(19) United States
(12) Patent Application Publication
(10) Pub. No.: US 2006/0045043 A1
(43) Pub. Date: Mar. 2, 2006

(54) Method and apparatus for facilitating PTT session initiation and service interaction using an IP-based protocol

(76) Inventors: Ronald T. Crocker, St. Charles, IL (US); John M. Harris, Chicago, IL (US); Thomas B. Hart, West Dundee, IL (US)

Correspondence Address: MOTOROLA, INC., 1303 EAST ALGONQUIN ROAD, IL01/3RD, SCHAUMBURG, IL, 60196, US

(21) Appl. No.: 10/931,188

(22) Filed: Aug. 31, 2004

(51) Int. Cl. H04Q 7/00

(52) U.S. Cl. 370/328; 370/352

(57) ABSTRACT

Various embodiments are described which can provide reduced PTT call setup times and a greater degree of service integration for PTT users. A PTT originator's MSC (171) notifies (205) the PTT server of a PTT session request before the originator (101) has the channel and data connection resources to send a PTT session request itself. This enables the PTT server (161) to trigger (207) the establishment of channel and data connection resources for the PTT target (102) before the originator is able to trigger the same by sending a PTT session request itself. Also, the target's MSC (172) notifies (221) the PTT server after the target responds to a page for the session, enabling the PTT server to indicate PTT session acceptance (223) on behalf of the target before the target has the channel and data connection resources to respond to a PTT session request.

### REFERENCE(S) TO RELATED APPLICATIONS(S)

This application is related to a co-pending application, Ser. No. 10/759,440, entitled “METHOD AND APPARATUS FOR FACILITATING A PTT SESSION INITIATION USING AN IP-BASED PROTOCOL,” filed Jan. 16, 2004, which is assigned to the assignee of the present application.

### FIELD OF THE INVENTION

The present invention relates generally to wireless communication systems and, in particular, to PTT session initiation and service interaction using an IP-based protocol.

### BACKGROUND OF THE INVENTION

In general, Internet Protocol (IP)-based protocols and processes are today being incorporated into telecommunications systems to provide a variety of internet-based services. Specifically, IP-based protocols such as the Session Initiation Protocol (SIP) are being selected and adapted for these systems. The Internet Engineering Task Force (IETF) may be contacted for a complete description of the SIP standard and specification. (See IETF RFC3261 and RFC2626, in particular.)

Generally SIP is a text-based protocol, similar to HTTP and SMTP, for initiating interactive communication sessions between users. Examples of potential session types include voice, instant messaging (IM), video, interactive games, and virtual reality. One particular use of IP-based protocols like SIP is to support push-to-talk (PTT) calls in Code Division Multiple Access (CDMA) systems. However, one problem such PTT services have is call setup times of around 10-15 seconds. Many users are likely to find such wait times for a service like PTT unacceptable. Another problem such PTT services have is a lack of integration with other services, in particular the lack of integration with ordinary voice services. For example, busy PTT users are not aware of incoming call attempts while they are active in a PTT call. Thus, it would be highly desirable to have a method and apparatus that could provide both substantially reduced PTT call setup times and a greater degree of service integration for PTT users.

### BRIEF DESCRIPTION OF THE DRAWINGS

FIG. 1 is a block diagram depiction of a wireless communication system in accordance with multiple embodiments of the present invention.

FIGS. 2a-2c, considered together (hereinafter “FIG. 2”), form a messaging flow diagram depicting session initiation messaging for a PTT request in accordance with multiple embodiments of the present invention.

FIGS. 3a-3b, considered together (hereinafter “FIG. 3”), form a messaging flow diagram depicting service interaction messaging while PTT calls are in progress, in accordance with multiple embodiments of the present invention.

FIGS. 4a-4b, considered together (hereinafter “FIG. 4”), form a messaging flow diagram depicting session initiation messaging for a PTT request for a scenario in which a target unit is busy, in accordance with multiple embodiments of the present invention.

### DETAILED DESCRIPTION OF EMBODIMENTS

Various embodiments are described which can provide reduced PTT call setup times and a greater degree of service integration for PTT users. A PTT originator's MSC notifies the PTT server of a PTT session request before the originator has the channel and data connection resources to send a PTT session request itself. This enables the PTT server to trigger the establishment of channel and data connection resources for the PTT target before the originator is able to trigger the same by sending a PTT session request itself. Also, the target's MSC notifies the PTT server after the target responds to a page for the session, enabling the PTT server to indicate PTT session acceptance on behalf of the target before the target has the channel and data connection resources to respond to a PTT session request. Thus, the user of the originating unit can be signaled to begin speaking even as the call is still being setup on the target-side. PTT call setup times can therefore be reduced by implementing some or all of these messaging techniques.

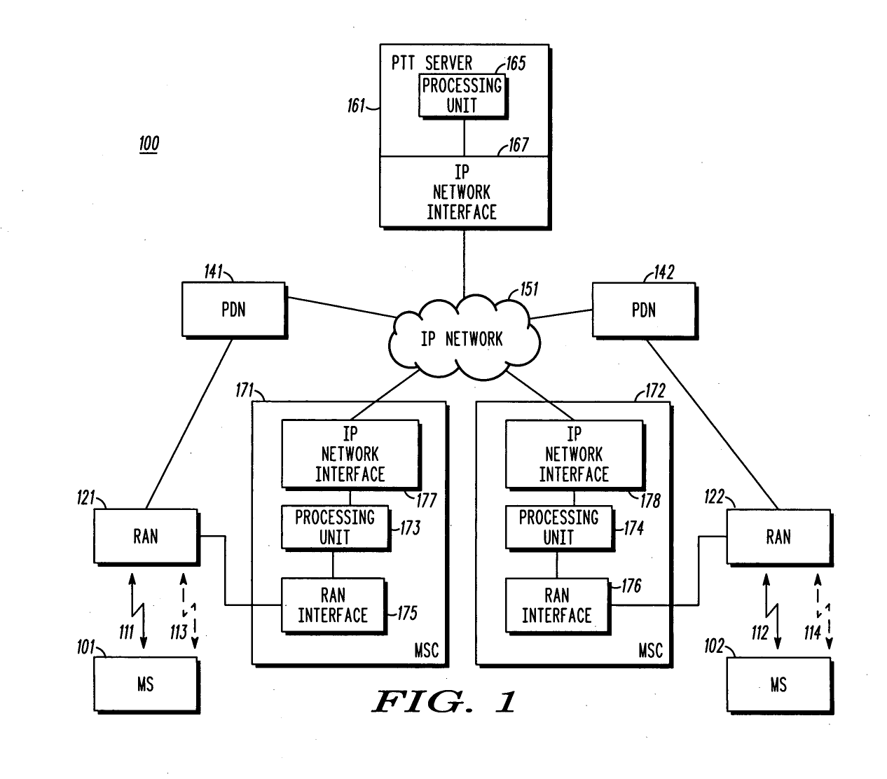

The disclosed embodiments can be more fully understood with reference to FIGS. 1-4. FIG. 1 is a block diagram depiction of a mobile communication system 100 in accordance with multiple embodiments of the present invention. Communication system 100 is a well-known Code Division Multiple Access (CDMA) system, specifically a cdma2000 system, which is based on the Telecommunications Industry Association/Electronic Industries Association (TIA/EIA) standards IS-2000 and IS-2001, suitably modified to implement the present invention. Alternative embodiments of the present invention may be implemented in communication systems that employ other technologies sufficiently similar to IS-2000 and IS-2001.

Those skilled in the art will recognize that FIG. 1 does not depict all of the network equipment necessary for system 100 to operate but only those system components and logical entities particularly relevant to the description of embodiments of the present invention. In particular, the network equipment of system 100 comprises components such as radio access networks (RANs) 121 and 122, mobile switching centers (MSCs) 171 and 172, packet data networks (PDNs) 141 and 142, internet protocol (IP) network 151, and PTT server 161. Generally, RANs, MSCs, PDNs, IP networks, and PTT servers are known in the art. For example, RANs are well-known to comprise components such as base station controllers (BSCS) and base transceiver systems (BTSs), neither of which are specifically shown in FIG. 1. Also, PDNs are well-known to comprise components such as packet data serving nodes (PDSNs) and packet control functions (PCFs).

MSCs 171 and 172 are depicted in FIG. 1 as respectively comprising processing units 173 and 174, RAN network interfaces 175 and 176, and IP network interfaces 177 and 178. PTT server 161 is depicted in FIG. 1 as comprising processing unit 165 and IP network interface 167. In general, components such as processing units and network interfaces are well-known. For example, processing units are known to comprise basic components such as, but not limited to, microprocessors, microcontrollers, memory devices, and/or logic circuitry. Such components are typically adapted to implement algorithms and/or protocols that have been expressed using high-level design languages or descriptions, expressed using computer instructions, expressed using messaging flow diagrams, and/or expressed using logic flow diagrams. Thus, given an algorithm, a logic flow, a messaging flow, and/or a protocol specification, those skilled in the art are aware of the many design and development techniques available to implement a processing unit that performs the given logic. Therefore, MSCs 171 and 172 and PTT server 161 respectively represent known MSCs and a known PTT server that have been adapted, in accordance with the description herein, to implement multiple embodiments of the present invention.

RANs 121 and 122 use air interfaces comprising channels 111-114 for communication with remote units 101 and 102. IS-2000 terminology refers to remote units as mobile stations (MSs); however, remote units are not necessarily mobile or able to move. Thus, remote unit/MS platforms are known in the art to include devices such as mobile phones, computers, personal digital assistants, gaming devices, etc. IS-2000 channels 111 and 112 each comprises a variety of well-known non-traffic channel types, such as broadcast channels, paging channels, access channels (i.e., access channels (ACHs) and enhanced access channels (EACHs)), and common control channels. IS-2000 channels 113 and 114 each comprise dedicated traffic channels, which are dynamically assigned and de-assigned to support user services.

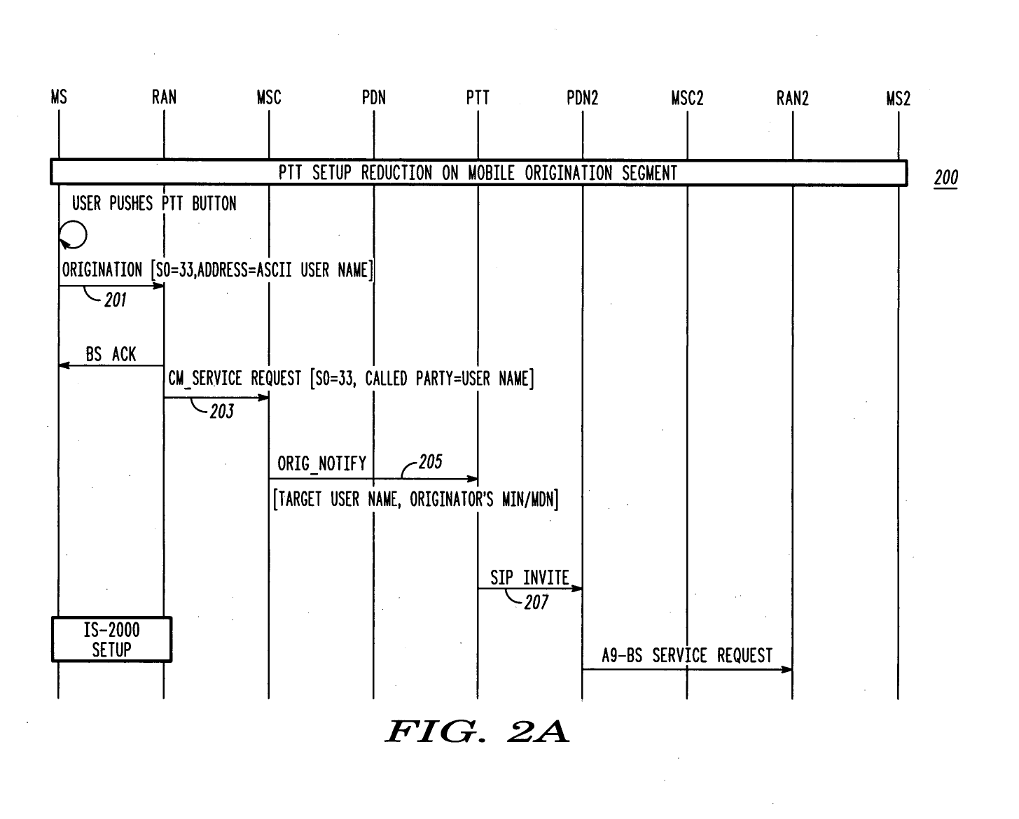

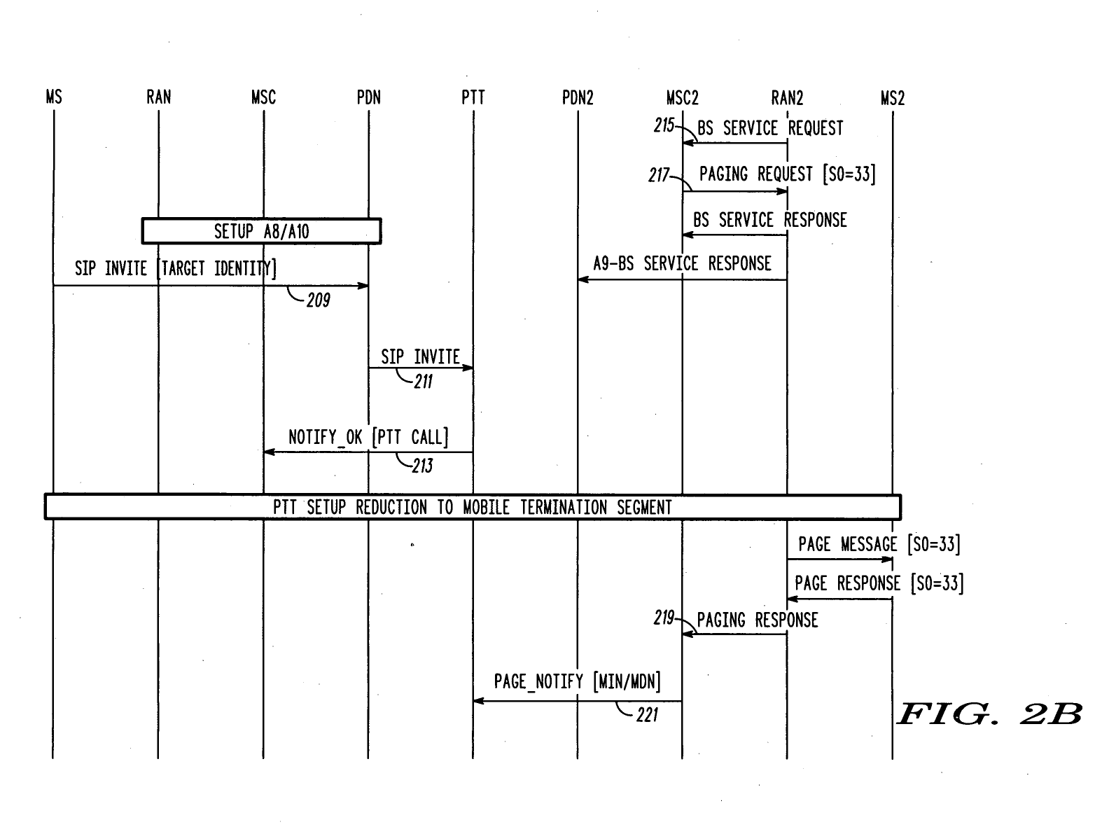

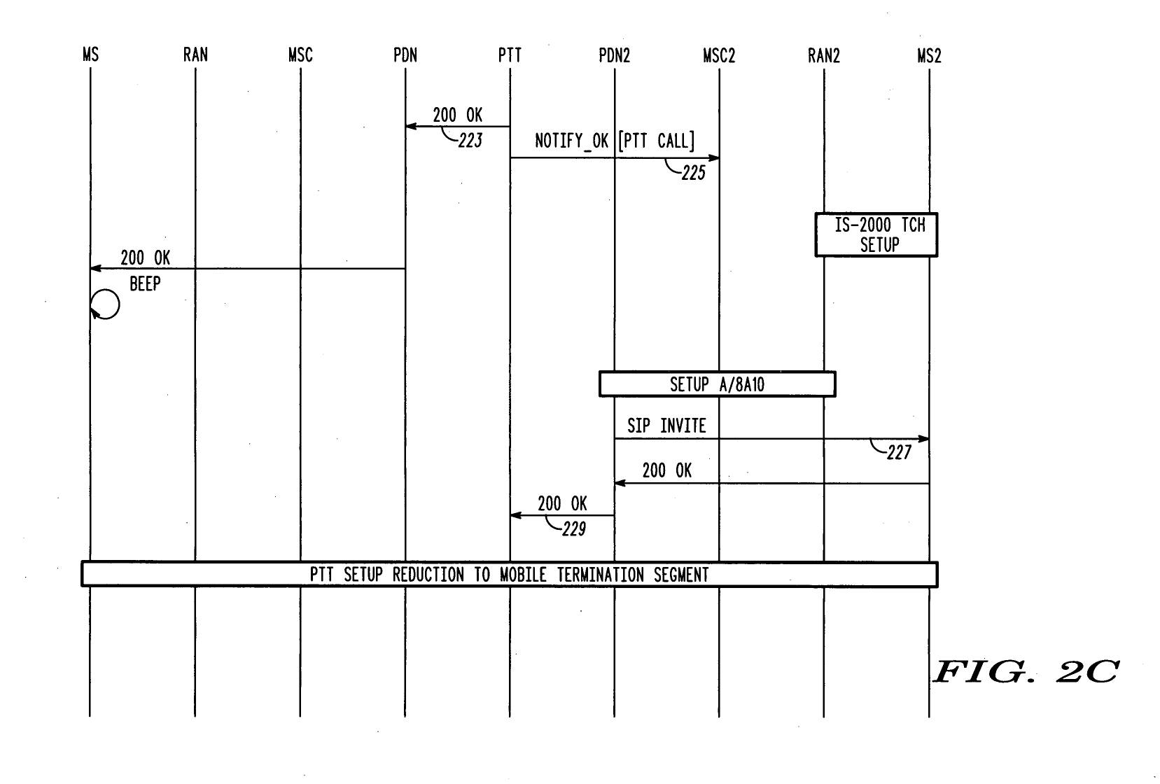

Operation of embodiments in accordance with the present invention occurs substantially as follows. FIG. 2 shows messaging flow diagram 200 depicting session initiation messaging for a PTT request in accordance with multiple embodiments of the present invention. Messaging flow diagram 200 assumes that MS 101 begins the flow in a dormant data state. In response to MS 101 detecting a user PTT call request, such as a PTT button being depressed by the MS user, MS 101 sends to RAN 121 a PTT call origination, such as Origination message 201, via a CDMA access channel, generically represented by air interface resource 111. Origination message 201 indicates that a packet data call is requested (i.e., service option 33) and includes PTT initiation information. Depending on the embodiment, the PTT initiation information may include PTT originator information (e.g., originator identification information), PTT call type information (e.g., group or individual), PTT target address information (e.g., an ASCII encoded PTT user name), and/or PTT server address information.

In response to the PTT call origination, RAN 121 generates a service request message, such as CM_Service Request message 203, for MSC 171. The service request message includes some or all of the PTT initiation information. For example, the PTT initiation information may be placed in a dialed digits message field within the service request message. Processing unit 173 receives the service request message via RAN interface 175 and generates a PTT session initiation request for PTT server 161 using the PTT initiation information received. In some embodiments, the PTT session initiation request may take the form of a SIP INVITE message or some similar IP-based message format. In other embodiments, the PTT session initiation request may simply take the form of a notification message, informing the PTT server of the PTT call origination and the MIN/MDN of the originator. Also, depending on the embodiment, the PTT initiation information may indicate the address of the target PTT server or processing unit 173 may maintain an MSC PTT server address table in which to look up PTT server 161's address. Processing unit 173 then sends the PTT session initiation request (message 205, e.g.) to PTT server 161 via IP network interface 177.

Processing unit 165 receives the PTT session initiation request via IP network interface 167. In response, processing unit 165 generates an IP-based session initiation request that includes server-generated PTT call context information. For example, PTT server 161 may generate a SIP INVITE message using the PTT initiation information received (e.g., the MIN/MDN indicated for MS 101) and PTT service information that PTT server 161 has stored for the originator unit (MS 101) and the target unit (MS 102, e.g.); together, the information received and the information stored are considered server-generated PTT call context information. Thus, processing unit 165 generates SIP INVITE message 207 to request a PTT session of the indicated PTT call type between MS 101 and a target unit (MS 102, e.g.) associated with the PTT target address. Processing unit 165 then sends the IP-based session initiation request, via IP network interface 167, to a component packet control function (PCF) associated with the target unit in PDN 142.

Having data to deliver to MS 102, PDN 142 requests data service from RAN 122, which in turn requests MSC 172 to page MS 102. Concurrently, RAN 121 and PDN 141 perform the signaling necessary to setup traffic channel (TCH) 113 and the A8/A10 connection that support the data service MS 101 requested. Unaware that PTT server 161 has already been notified of the PTT call request from MS 101 by MSC 171, MS 101 may generate an IP-based session initiation request such as SIP INVITE message 209. The IP-based session initiation request includes originator-generated PTT call context information for the PTT session with the target unit.

Processing unit 165 receives the IP-based session initiation request (e.g., SIP INVITE message 211) via IP network interface 167, stores the originator-generated PTT call context information, and associates the originator-generated call context information with the server-generated call context information. Recognizing that this most recent session initiation request corresponds to the same PTT call as the earlier session initiation request from MSC 171, processing unit 165 may respond, but to MSC 171 instead of MS 101. This PTT initiation response messaging, such as notification message 213, uses the originator-generated PTT call context information and serves to notify MSC 171 that MS 101 is presently busy with a PTT call. In other embodiments, PTT server 161 may recognize that the most recent session initiation request corresponds to the same PTT call as the earlier session initiation request from MSC 171 and therefore simply discard it.

Meanwhile, target-side messaging is able to proceed in parallel with the originator-side messaging. PDN 142 requests data service from RAN 122, which in turn requests MSC 172 to page MS 102. More specifically, MSC processing unit 174 receives, via RAN interface 176, a service request for participation by MS 102 in a PTT session. This service request may take the form of BS Service Request message 215, for example. In response, MSC processing unit 174 determines whether the target unit is available for participation in the PTT session. For example, MSC processing unit 174 may consider whether MS 102 has deregistered, whether MS 102 is currently busy in a voice call, or whether MS 102 has a non-data service pending page. Any of these would indicate that MS 102 is unavailable for participation in the PTT session.

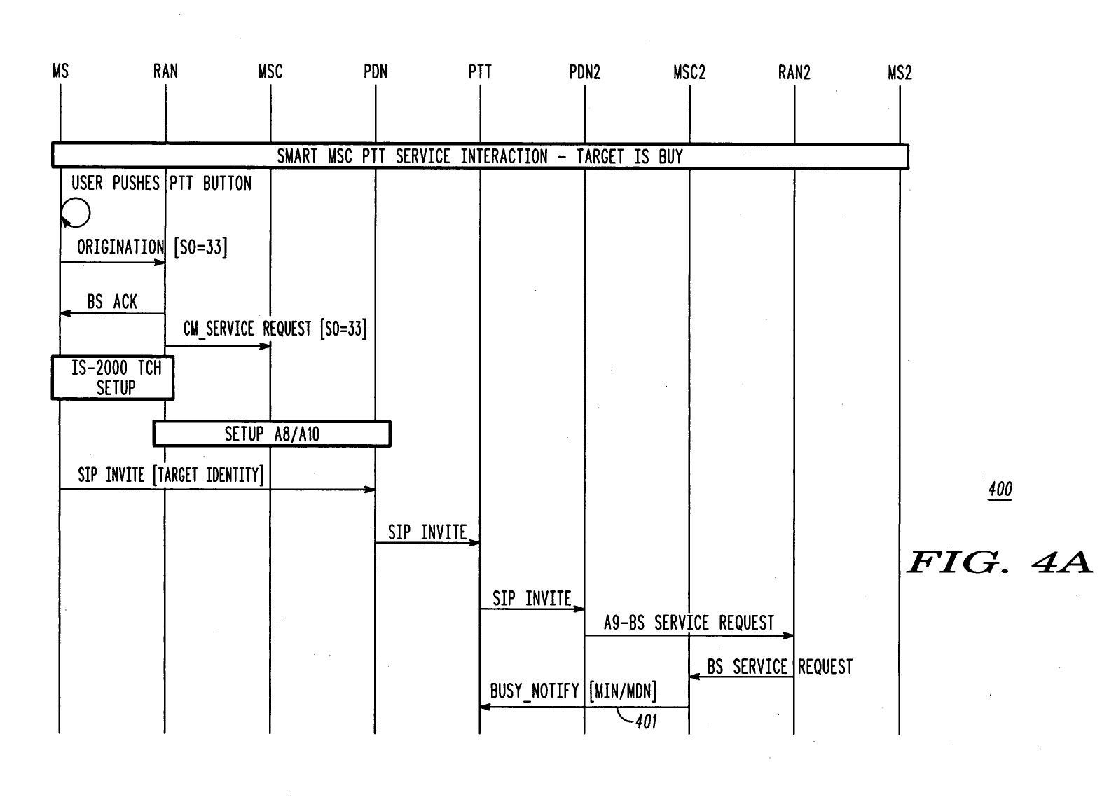

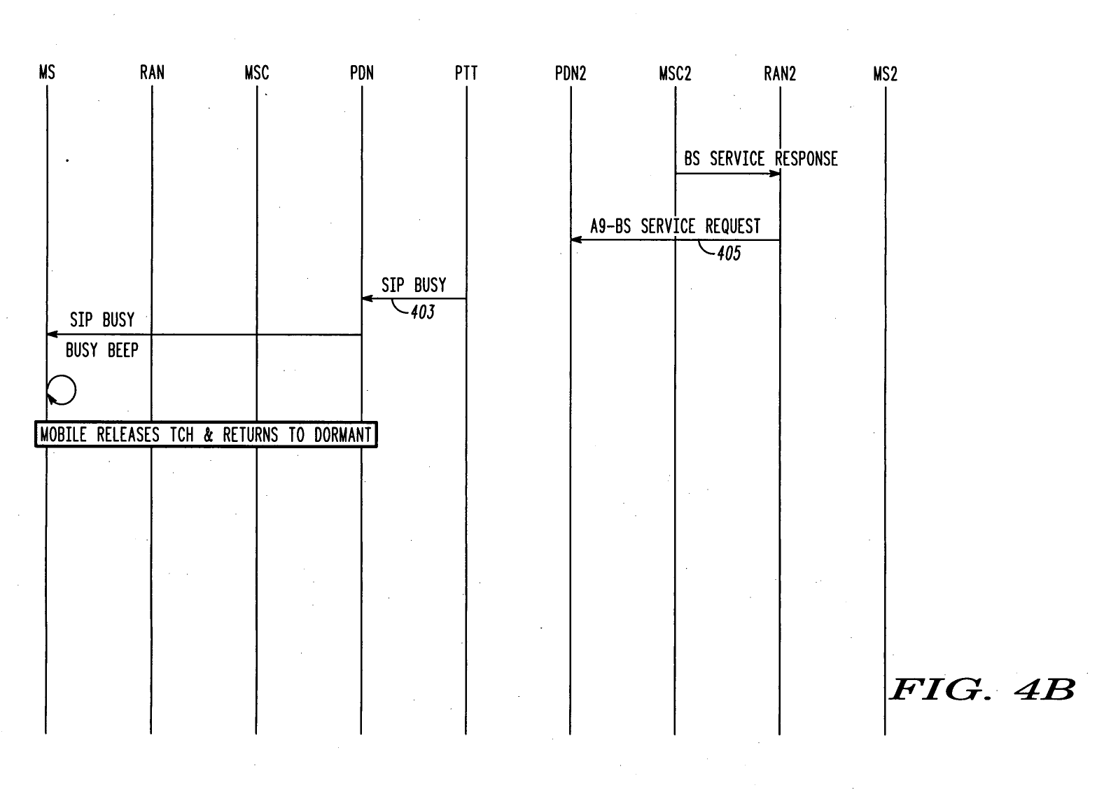

For example, FIG. 4 shows messaging flow diagram 400, which depicts session initiation messaging for a PTT request for a scenario in which a target unit is busy, in accordance with multiple embodiments of the present invention. When the target unit is determined to be unavailable for participation in the PTT session, MSC processing unit 174 generates response messaging, such as busy notification message 401, that indicates that MS 102 will not participate in the PTT session. This response messaging is then sent to PTT server 161 via IP network interface 178.

In some embodiments where MSCs generate IP-based messaging, the response messaging generated by MSC processing unit 174 may comprise a SIP 486 BUSY HERE message or something similar. Regardless the form of the response messaging received by PTT server 161, PTT server 161 sends busy messaging 403 to convey the busy state of the target unit to MS 101. PDN 142 is also notified of the target's busy state by message 405. PDN 142 had earlier received SIP INVITE message 207 for the target unit. The component packet control function (PCF) associated with the target unit in PDN 142 continues to store the messaging for later delivery.

Although the scenario in which MS 102 is unavailable for participation in the PTT session because it is busy is discussed in detail above, MS 102 may be unavailable for other reasons. However, MSC 171 will still generate response messaging for PTT server 161 that indicates that MS 102 will not participate in the PTT session but just not because the target is busy. PTT server 161 will then send session rejection messaging to convey the unavailable state of the target unit to MS 101.

Returning to FIG. 2, messaging flow diagram 200 depicts the alternative scenario in which the target unit is available for participation in the PTT session. When the target unit is determined to be available for participation in the PTT session, MSC processing unit 174 pages the target unit via the RAN interface 176. To page MS 102, MSC 172 sends paging request 217 to RAN 122 indicating the service option 33 for packet data service.

Assuming that MS 102 responds to the page, MSC 172 receives page response message 219 indicating that the target unit responded to the page. In response, MSC processing unit 174 generates response messaging that indicates that the target unit will participate in the PTT session and sends it to PTT server 161 via IP network interface 178. Depending on the embodiment, this response messaging may take the form of notification message 221 or a SIP 200 OK message, for example.

PTT processing unit 165 receives the response messaging indicating that the target unit will participate in the PTT session via IP network interface 167. In response, PTT processing unit 165 generates IP-based session acceptance messaging, such as SIP 200 OK message 223, using the response messaging received and sends it on to the originator unit. In some embodiments, PTT server 161 may also send some notification messaging, such as notification message 225, to notify MSC 172 that MS 102 should be considered busy with a PTT call. Notification message 225, like notification message 213, enable MSCs 171 and 172 to provide some service interaction functionality between the primarily data-side PTT service and the other services that the MSCs are involved with, such as voice calls.

After a data connection is established for MS 102, PDN 142 sends its buffered session initiation information (SIP INVITE message 207 that includes the server-generated PTT call context information) to MS 102 in the form of SIP INVITE message 227. From the target unit via IP network interface 167, PTT server processing unit 165 receives session acceptance messaging, such as SIP 200 OK message 229 that includes the server-generated PTT call context information, intended for the originator unit. PTT server 161 may respond to the session acceptance messaging with an acknowledgement to MS 102, perhaps including the server-generated PTT call context information, but PTT server 161 does not convey this session acceptance to the originator. It is unnecessary to do so, since PTT server 161 already sent MS 101 session acceptance messaging (SIP 200 OK message 223, e.g.) upon being notified that the target unit will participate in the PTT session per MS 102's earlier page response. In fact, a PTT speech path is already established between MS 101 and MS 102 at this point without the need for additional setup messaging.

In summary, the embodiments described above can provide substantially reduced PTT call setup times, since the originator's MSC notifies the PTT server (message 205, e.g.) of a PTT session request long before the originator has the channel and data connection resources to send a PTT session request itself. This enables the PTT server to trigger (message 207, e.g.) the establishment of channel and data connection resources for the target unit (or group) before the originator is able to trigger the same by sending a PTT session request itself. Also, the target's MSC notifies (message 221, e.g.) the PTT server after the target responds to a page for the session, enabling the PTT server to indicate PTT session acceptance (message 223, e.g.) on behalf of the target unit before the target unit has the channel and data connection resources to respond to a PTT session request. Thus, the user of the originating unit can be signaled to begin speaking even as the call is still being setup on the target-side. Thus, PTT call setup times can be reduced by implementing some or all of these messaging techniques.

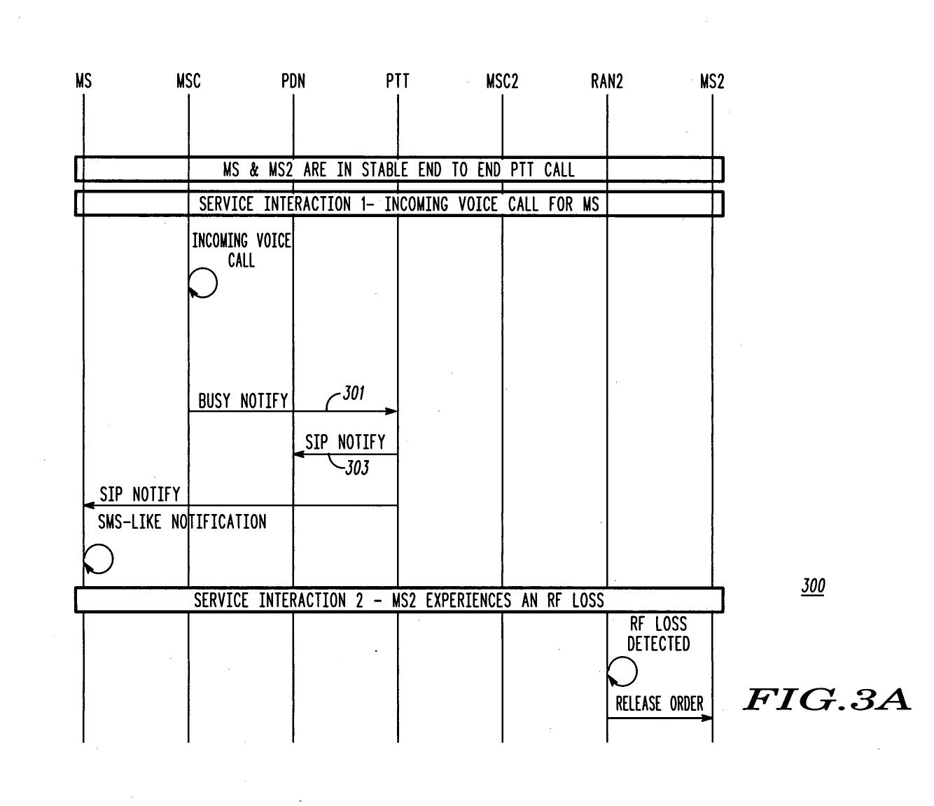

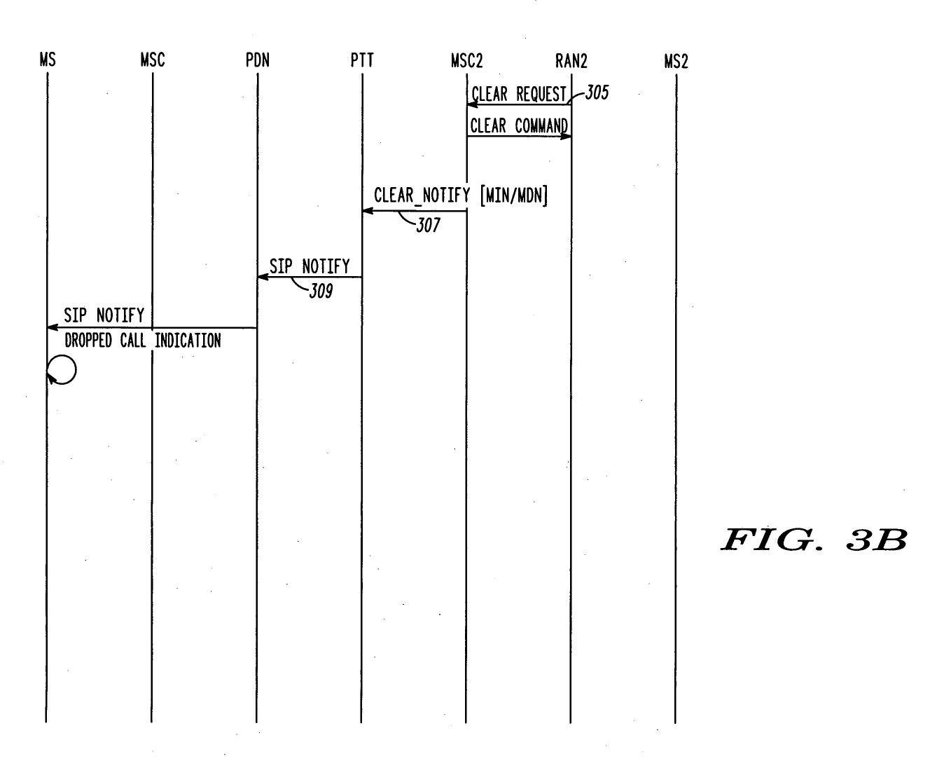

In addition, the embodiments herein can provide greater service integration for PTT users. FIG. 3 shows a messaging flow diagram 300 that depicts service interaction messaging while PTT calls are in progress, in accordance with multiple embodiments of the present invention. With a PTT session in progress between MS 101 and MS 102, MSC 171 receives a service request for MS 101 to participate in another service, such as an incoming voice call. In response, MSC 171 sends an indication, such as message 301, to PTT server 161 that MS 101 has received a service request while busy. In addition, MSC 171 may indicate the CLI how the service request was handled, for example, forwarded to voice mail, provided a busy indication, etc. PTT server 161, in turn, receives this indication and sends an indication to MS 101, such as message 303, that indicates that a service request has been received for MS 101. This indication to MS 101 may take the form of a SIP NOTIFY message and may include the CLI and indicate how the service request was handled. After receiving the indication of the other service request, MS 101 may provide this information to the user during the ongoing PTT session. Finally, although messaging flow diagram 300 depicts busy messaging triggered by a service request for the originator unit, similar messaging would occur on the target-side for a service request for the target unit.

Messaging flow diagram 300 also depicts service interaction messaging for the case where an RF loss occurs between RAN 122 and MS 102 while a PTT session is in progress between MS 101 and MS 102. MSC 172 receives an indication, such as Clear Request message 305, that the wireless connection with MS 102 has been lost. In response, MSC processing unit 174 sends connection-lost messaging, such as notification message 307, to PTT server 161 via IP network interface 178 to indicate a disruption of the PTT session. PTT server 161, in turn, receives the connection-lost messaging and sends an indication to MS 101, such as message 309, that indicates that the PTT session has ended. This indication to MS 101 may take the form of a SIP BYE message, a SIP 410 Gone message, or a SIP 480 Temporarily Not Available message. After receiving the indication that the PTT session has ended, MS 101 conveys to the user that the PTT call dropped. Lastly, although messaging flow diagram 300 depicts connection-lost messaging for the target unit, similar messaging (i.e., mirror image messaging) would occur for a lost connection with the originator unit.

In the foregoing specification, the present invention has been described with reference to specific embodiments. However, one of ordinary skill in the art will appreciate that various modifications and changes may be made without departing from the spirit and scope of the present invention as set forth in the appended claims. For example, although a target unit refers to a single MS throughout, a target unit could also encompass a PTT group as a target. Accordingly, the specification and drawings are to be regarded in an illustrative rather than a restrictive sense, and all such modifications are intended to be included within the scope of the present invention. In addition, those of ordinary skill in the art will appreciate that the elements in the drawings are illustrated for simplicity and clarity, and have not necessarily been drawn to scale. For example, the dimensions of some of the elements in the drawings may be exaggerated relative to other elements to help improve an understanding of the various embodiments of the present invention.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims. As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, computer program, and computer instructions, as used herein, are defined as a sequence of instructions designed for execution on a computer system. This sequence of instructions may include, but is not limited to, a subroutine, a function, a procedure, an object method, an object implementation, an executable application, an applet, a servlet, a shared library/dynamic load library, a source code, an object code and/or an assembly code.

What is claimed is:

1. A method for facilitating push-to-talk (PTT) session initiation and service interaction using an Internet Protocol (IP)-based protocol, the method comprising:
receiving, by a mobile switching center (MSC), origination messaging from an originator unit that includes PTT initiation information;
generating, by the MSC, a PTT session initiation request using the PTT initiation information; and
sending, by the MSC, the PTT session initiation request to a PTT server.

2. The method of claim 1, wherein receiving the origination messaging comprises receiving the PTT initiation information in a dialed digits message field.

3. The method of claim 1, wherein the origination messaging indicates identification information for the originator unit and that a packet data call is requested.

4. The method of claim 1, wherein the PTT initiation information comprises information from the group consisting of PTT originator information, PTT call type information, PTT target address information, and PTT server address information.

5. The method of claim 1, wherein the PTT session initiation request comprises a SIP INVITE message and
wherein the PTT session initiation request includes information based on the PTT initiation information received in the origination messaging

6. The method of claim 1, wherein sending the PTT session initiation request comprises sending the session initiation request to the PTT server via IP-messaging, wherein a PTT server address is obtained from a source from the group consisting of the PTT initiation information and an MSC PTT server address table.

7. The method of claim 1, further comprising:
receiving, by the MSC, an indication that a wireless connection with the originator unit has been lost, wherein the wireless connection with the originator unit supported a PTT session; and
sending, by the MSC in response to the indication that a wireless connection with the originator unit has been lost, connection-lost messaging to the PTT server to indicate a disruption of the PTT session.

8. The method of claim 7, wherein sending the connection-lost messaging comprises sending the connection-lost messaging to the PTT server via IP-messaging.

9. The method of claim 1, further comprising:
receiving, by the MSC while the originator unit is participating in the PTT session, a service request for the originator unit to participate in another service; and
sending, by the MSC in response to the service request for the originator unit to participate in another service, an indication that the originator unit has received a service request while busy.

10. A method for facilitating push-to-talk (PTT) session initiation and service interaction using an Internet Protocol (IP)-based protocol, the method comprising:
receiving, by a PTT server from a mobile switching center (MSC), a PTT session initiation request that includes a PTT call type and a PTT target address;
generating, by the PTT server, an IP-based session initiation request for a PTT session for the PTT call type, between an originator unit and a target unit associated with the PTT target address, wherein the session initiation request comprises server-generated PTT call context information; and
sending, by the PTT server, the IP-based session initiation request to a packet control function (PCF) associated with the target unit.

11. The method of claim 10, wherein the IP-based protocol comprises Session Initiation Protocol (SIP).

12. The method of claim 10, wherein the IP-based session initiation request comprises a SIP INVITE message.

13. The method of claim 10, further comprising:
after sending the IP-based session initiation request, receiving, by the PTT server, a second IP-based session initiation request for the PTT session, wherein the second IP-based session initiation request is from the originator unit, wherein the session initiation request comprises originator-generated PTT call context information.

14. The method of claim 13, further comprising:
storing, by the PTT server, the originator-generated PTT call context information;
associating, by the PTT server, the server-generated call context information and the originator-generated call context information; and
responding, by the PTT server, to the second IP-based session initiation request with PTT initiation response messaging using the originator-generated PTT call context information.

15. The method of claim 10, further comprising:
receiving, by the PTT server from an MSC associated with the target unit, response messaging that indicates that the target unit will participate in the PTT session; and
sending, by the PTT server in response to the response messaging, session acceptance messaging to the originator unit based on the response messaging.

16. The method of claim 15, wherein sending the session acceptance messaging comprises
generating, by the PTT server, IP-based session acceptance messaging using the response messaging.

17. The method of claim 16, wherein the IP-based session acceptance messaging comprises a SIP 200 OK message.

18. The method of claim 15, further comprising:
after sending the session acceptance messaging, receiving, by the PTT server, session acceptance messaging for the PTT session from the target unit and intended for the originator unit; and
discarding, by the PTT server, the session acceptance messaging from the target unit.

19. The method of claim 10, further comprising:
receiving, by the PTT server from the MSC, connection-lost messaging that indicates a disruption of the PTT session with the originating unit; and
sending, by the PTT server, an indication to the target unit that the PTT session has ended.

20. The method of claim 19, wherein the indication to the target unit that the PTT session has ended comprises a message from the group consisting of a SIP BYE message, a SIP 410 Gone message, and a SIP 480 Temporarily Not Available message.

21. The method of claim 10, further comprising:
receiving, by the PTT server from an MSC associated with the target unit, connection-lost messaging that indicates a disruption of the PTT session; and
sending, by the PTT server, an indication to the originator unit that the PTT session has ended.

22. The method of claim 10, further comprising:
receiving, by the PTT server from an MSC associated with the target unit, an indication that the target unit is unavailable to participate in the PTT session; and
sending, by the PTT server, session rejection messaging to the originating unit indicating that the target unit is unavailable to participate in the PTT session.

23. The method of claim 10, further comprising:
receiving, by the PTT server from the MSC, an indication that a PTT unit has received a service request while busy; and
sending, by the PTT server, an indication to the PTT unit that a service request has been received for the PTT unit.

24. The method of claim 23, wherein the indication to the PTT unit that a service request has been received for the PTT unit comprises a SIP NOTIFY message.

25. A method for facilitating push-to-talk (PTT) session initiation and service interaction using an Internet Protocol (IP)-based protocol, the method comprising:
receiving, by a mobile switching center (MSC), a service request for participation in a PTT session by a target unit;
determining, by the MSC, whether the target unit is available for participation in the PTT session;
when the target unit is determined to be available for participation in the PTT session,
paging, by the MSC, the target unit and
generating, by the MSC when an indication that the target unit responded to the page is received, response messaging that indicates that the target unit will participate in the PTT session;
when the target unit is determined to be unavailable for participation in the PTT session,
generating, by the MSC, response messaging that indicates that the target unit will not participate in the PTT session; and
sending, by the MSC, the response messaging to the PTT server.

26. The method of claim 25, wherein the service request comprises a BS Service Request message that requests a packet data service.

27. The method of claim 25, wherein determining whether the target unit is available for participation in the PTT session comprises determining that the target unit is available when a condition is present from the group consisting of the target unit has registered, the target unit is not currently busy in a voice call, and the target unit is not in a state indicating it has a non-data service page pending.

28. The method of claim 25, wherein determining whether the target unit is available for participation in the PTT session comprises determining that the target unit is unavailable when a condition is present from the group consisting of the target unit is busy in a voice call, the target unit has deregistered, and the target unit has a non-data service pending page.

29. The method of claim 25, wherein paging the target unit comprises paging the target unit for a packet data service.

30. The method of claim 25, wherein the response messaging that indicates that the target unit will participate in the PTT session comprises a SIP 200 OK message.

31. The method of claim 25, wherein the response messaging that indicates that the target unit will not participate in the PTT session comprises a SIP 486 BUSY HERE message.

32. The method of claim 25, wherein the response messaging is sent via IP messaging.

33. The method of claim 25, further comprising:
receiving, by the MSC, an indication that a wireless connection with the target unit has been lost, wherein the wireless connection with the target unit supported the PTT session; and
sending, by the MSC in response to the indication that a wireless connection with the target unit has been lost, connection-lost messaging to the PTT server to indicate a disruption of the PTT session.

34. The method of claim 33, wherein sending the connection-lost messaging comprises sending the connection-lost messaging to the PTT server via IP-messaging.

35. The method of claim 25, further comprising:
receiving, by the MSC while the target unit is participating in the PTT session, a service request for the target unit to participate in another service; and
sending, by the MSC in response to the service request for the target unit to participate in another service, an indication that the target unit has received a service request while busy.

36. A mobile switching center (MSC) for facilitating push-to-talk (PTT) session initiation and service interaction using an Internet Protocol (IP)-based protocol, the MSC comprising:
a radio access network (RAN) interface adapted to send and receive messaging to and from a RAN;
an IP network interface adapted to send and receive messaging to and from an IP network; and
a processor, communicatively coupled to the RAN interface and the IP network interface,
adapted to receive, via the RAN interface, origination messaging from an originator unit that includes PTT initiation information;
adapted to generate a PTT session initiation request using the PTT initiation information; and
adapted to send, via the IP network interface, the PTT session initiation request to a PTT server.

37. A push-to-talk (PTT) server for facilitating PTT session initiation and service interaction using an Internet Protocol (IP)-based protocol, the PTT server comprising:
an IP network interface adapted to send and receive messaging to and from an IP network; and
a processor, communicatively coupled to the IP network interface,
adapted to receive, from a mobile switching center (MSC) via the IP network interface, a PTT session initiation request that includes a PTT call type and a PTT target address;
adapted to generate an IP-based session initiation request for a PTT session for the PTT call type, between an originator unit and a target unit associated with the PTT target address, wherein the session initiation request comprises server-generated PTT call context information; and
adapted to send, via the IP network interface, the IP-based session initiation request to a packet control function (PCF) associated with the target unit.

38. A mobile switching center (MSC) for facilitating push-to-talk (PTT) session initiation and service interaction using an Internet Protocol (IP)-based protocol, the MSC comprising:
a radio access network (RAN) interface adapted to send and receive messaging to and from a RAN;
an IP network interface adapted to send and receive messaging to and from an IP network; and
a processor, communicatively coupled to the RAN interface and the IP network interface,
adapted to receive, via the RAN interface, a service request for participation in a PTT session by a target unit;
adapted to determine whether the target unit is available for participation in the PTT session;
adapted to page, via the RAN interface, the target unit when the target unit is determined to be available for participation in the PTT session;
adapted to generate response messaging that indicates that the target unit will participate in the PTT session, when an indication that the target unit responded to the page is received;
adapted to generate response messaging that indicates that the target unit will not participate in the PTT session, when the target unit is determined to be unavailable for participation in the PTT session; and
adapted to send, via the IP network interface, the response messaging to the PTT server.
